(19) United States
(12) Patent Application Publication
(10) Pub. No.: US 2019/0289480 A1
(43) Pub. Date: Sep. 19, 2019

(54) Smart Building Sensor Network Fault Diagnostics Platform

(71) Applicant: Bridgewest Ventures LLC, San Diego, CA (US)

(72) Inventor: Saeid Safavi, San Diego, CA (US)

(21) Appl. No.: 16/355,474

(22) Filed: Mar. 15, 2019

Related U.S. Application Data
(60) Provisional application No. 62/643,868, filed on Mar. 16, 2018.

(51) Int. Cl. H04W 24/08

(52) U.S. Cl. CPC H04W 24/08; H04L 12/2803

(57) ABSTRACT

An approach for diagnosing degradations in performance and malfunctions in sensor networks is disclosed. This approach is based on so-called “fault signatures”. Such fault signatures are generated for known fault conditions through a statistical analysis process that results in each known fault having a unique fault signature. Such unique fault signatures can then point to the root cause of a problem.

### CROSS-REFERENCE TO RELATED APPLICATIONS—CLAIM OR PRIORITY

The present application claims priority to U.S. Provisional Application No. 62/643,868, filed on Mar. 16, 2018, entitled “Smart Building Sensor Network Fault Diagnostics Platform”, which is herein incorporated by reference in its entirety.

### BACKGROUND

### (1) Technical Field

Systems and methods for managing a smart home network and more particular a method and apparatus for diagnosing performance of a sensor network within a smart home.

### (2) Background

Smart homes have started to become more popular recently. Smart homes are home environments in which the occupant can monitor and control features and devices of the home, such as lights, thermostat, manage the contents of the refrigerator, play music with voice commands, etc. As smart homes get more sophisticated, several sensors are being installed in such smart homes. With the unprecedented growth in the number of sensors and actuators in smart homes, buildings, public venues, and industrial applications, the importance of having smart fault diagnostics of these networks continues to grow. In most cases, network connectivity between devices in such smart homes is provided in accordance with wireless standards (e.g., WiFi, BT, LoRaWAN, 6loWPAN, NB-IoT, etc.). Such networks are usually deployed with minimal or no site survey. This is true, even when the network is installed by a professional network management team. Many instances in which “Internet of Things” (IoT) devices are connected to a smart home network require the data that flows between the IoT device and the network to be managed through a data application that can operate within a poorly designed sensor network. In many such instances, the interface between the IoT device and the network will not run optimally. That is, a significant number of retransmissions may occur, power consumption may increase and significant delay may occur, even in delay sensitive use cases. Oftentimes, this problem will remain unnoticed for data applications that can withstand a greater number of layer 2 retransmissions (as a result of re-transmissions). However, applications like URLLC (Ultra-Reliable Low Latency Communications) are more susceptible to late or inconsistent packet delivery due to these retransmissions.

Therefore, there is current a need for a smart home network that can operate efficiently with an array of sensors that each have different network requirements and conditions.

### DESCRIPTION OF THE DRAWINGS

FIG. 1 illustrates one embodiment of the disclosed method and apparatus in which the diagnostics engine uses two processes to detect fault conditions.

FIG. 2 is an illustration of an analytics solutions platform.

FIG. 3 is an illustration of one example of an architecture that can be implemented in some embodiments of the disclosed method and apparatus to provide fault detection and analysis in accordance with the disclosed method and apparatus.

FIG. 4 is an illustration of an architecture that may be implemented in one example of the disclosed method and apparatus.

FIG. 5 is an illustration of another example of an architecture in which a fault diagnostic client 502 communicates with a fault diagnostic server 504 through the internet 506.

FIG. 6 is an illustration of a smart home environment 600 and the associated logical components of such a smart home environment 600 in accordance with the disclosed method and apparatus.

Like reference numbers and designations in the various drawings indicate like elements.

### DETAILED DESCRIPTION

Smart home systems and other networks that require an array of sensor devices and other “Internet of Things” (IoT) devices to pass data over a local area network can benefit from a system that enables an understanding of and ability to address IoT networking issues. In accordance with the disclosed method and apparatus, a system is provided that includes a diagnostic platform that can capture radio signal impairments. Capturing such radio signal impairments will greatly assist with fault diagnostics in general. This is because identifying major contributors to connectivity issues (or ruling out such contributors) allows the contributing issues, such as “Network problems”, or “Software Bugs”, to be more effectively isolated so that they can be dealt with.

The disclosed method and apparatus provides an approach for diagnosing degradations in performance and malfunctions in sensor networks. This approach is based on so-called “fault signatures”. Such fault signatures are generated for known fault conditions through a statistical analysis process that results in each known fault having a unique fault signature. Such unique fault signatures can then point to the root cause of a problem.

In some embodiments, fault signatures are generated using preliminary “testbed experiments”. The generated fault signatures help in diagnosing network faults and distinguishing them from legitimate network events. In addition, variations in time that occur as a nature consequence of a normally functioning network can be distinguished from conditions that typically exist in a network that is experiencing fault conditions.

The algorithmic approach of the disclosed method and apparatus ensures that the root cause of a fault condition is identification by capturing the state of selected network parameters before a fault and comparing them the conditions during the occurrence of a fault. In some embodiments, the fault diagnostics platform is more accurate and, at the same time, more generic. This is accomplished by providing a fault diagnostics platform that can learn and adjust to various networking scenarios that are unique to the particular network in which the fault diagnostic platform is operating. In one embodiment, this is achieved by creation of a “3D fault signature cubic matrix” concept.

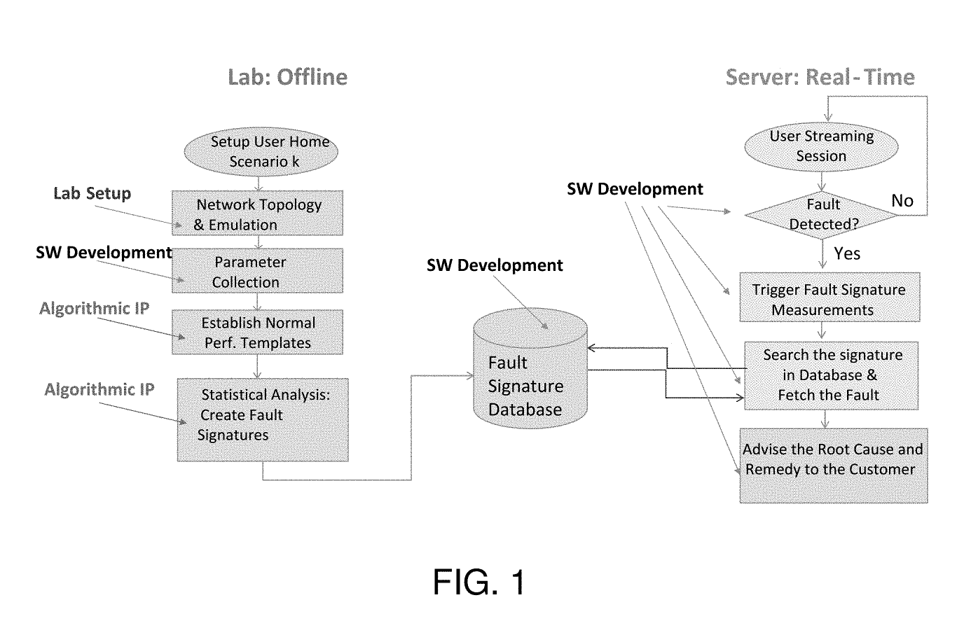

FIG. 1 illustrates one embodiment of the disclosed method and apparatus in which the diagnostics engine uses two processes to detect fault conditions. The first process is an offline, “lab-based” process. In the offline, lab-based process, a “testbed” is used. The testbed is configured for use with a specific user network. In some embodiments, the network includes both the wired and the wireless segments. The wired segment constitutes a specific network topology that is under investigation. This topology may include specific sensor devices, a network of wireless connections conforming to a particular wireless industry standard, and any wired media (e.g., twisted pair, coaxial cable, etc.) that may be the source of a network fault. The wireless segment is modeled in the emulator by implementing standard channel models. Alternatively, the wireless segment may be modeled using custom channel models that can reproduce a specific user's home/building type and topology.

The offline process starts by configuring the wired and wireless segments of the network in order to establish performance templates for a fault free or “normal” network. These will include various samples of fault signature tracking parameters. These typically form a vector in a time series. Accordingly, each parameter has values associated with various points in time to establish the “vector in a time series”.

A second process is a real-time or online process. In some embodiments, the online process is continuously run on a centralized diagnostics server (or sever farm). The process starts after signs of an anomaly are detected (e.g., evidence is detected that a potential fault condition exists or is eminent). Such real-time online detection is performed by continuous monitoring higher layer parameters at the application level (such and bandwidth, delay, jitter, etc.). Once a potential anomaly or fault is detected, a next level of granularity in monitoring is started. In this next level of monitoring, a set of parameters used to establish each fault signature is correlated across layers. This is repeated for each fault and the signatures are constantly compared to a baseline, until an exact match (or the best match) is found.

Accordingly, fault diagnostics are provided for sensor/actuator networks, based on fault signature capture. The disclosed method and apparatus can be used as part of network management entity for smart homes/buildings as well as public venues, and places. A novel cross-layer approach is used to provide fault detection and analysis.

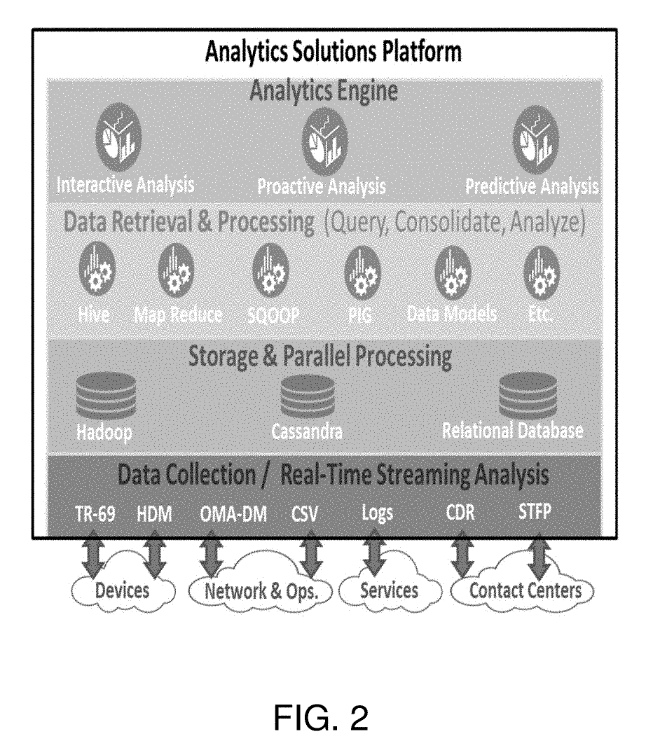

FIG. 2 is an illustration of an analytics solutions platform. In some embodiments, generation of fault signatures, comparison and correlation of signatures and general fault analysis is performed by an analytics solution platform, such as shown in FIG. 2.

The following are examples of network analytics frameworks based on machine learning used within a platform, such as that shown in FIG. 2. These frameworks include:

(1) Scalable data collection and real-time streaming analytics;

(2) Massive parallel processing and storage;

(3) Data retrieval and processing;

(4) Analytics engine and business intelligence; and

(5) Domain-specific analytics solutions.

Scalable data collection and real-time streaming analytics allows operators to collect and store any data, as often as they need. TR-069 (Technical Report 069) is a technical specification of the Broadband Forum that defines an application layer protocol for remote management of customer-premises equipment (CPE) connected to an Internet Protocol (IP) network. TR-069 and streaming video QoE (quality of experience) clients can be used to collect data from devices. The video can be analyzed using image recognition to detect features and derive data for use by the processing engine of the QoE estimation module. In some embodiments, data is collected about network operations, services, and call center interactions using, for example, Comma separated Value (CSV) files, logs, CDRs (a proprietary file format primarily used for vector graphic drawings), and Secure File Transfer Protocol (SFTP). A CSV is a comma separated values file that allows data to be saved in a table structured format. CSVs look like garden-variety spreadsheets. However, CVS files have a “.csv extension”. Traditionally they take the form of a text file containing information separated by commas, hence the name. A CDR is a file extension for a vector graphics file used by Corel Draw, a popular graphics design program. Corel Paint Shop Pro and Adobe illustrator 9 and later can also open some CDR files. FTP (File Transfer Protocol) is a popular method of transferring files between two remote systems. SFTP is a separate protocol packaged with SSH that works in a similar way over a secure connection.

Massive parallel processing and storage uses HADOOP for big data storage and batch processing, CASSANDRA for real-time data analytics (for example, for real-time customer support), and relational database for data storage for reports and dashboard tools. HADOOP is an open source, Java-based programming framework that supports the processing and storage of extremely large data sets in a distributed computing environment. It is part of the Apache project sponsored by the Apache Software Foundation. Apache CASSANDRA is a free and open-source distributed NoSQL database management system designed to handle large amounts of data across many commodity servers, providing high availability with no single point of failure. A NoSQL (originally referring to “non SQL” or “non-relational”) database provides a mechanism for storage and retrieval of data that is modeled in means other than the tabular relations used in relational databases.

Data retrieval and processing can be used that is built on top of HADOOP, and is used for data querying and analysis—using data processing frameworks and tools, such as HIVE (a key component of the HADOOP ecosystem, MapReduce, and SQOOP. SQOOP supports incremental loads of a single table or a free form SQL query as well as saved jobs which can be run multiple times to import updates made to a database since the last import. Imports can also be used to populate tables in Hive or HBase.

Analytics engine and business intelligence consolidates, correlates, and analyzes data for automated actions or human interpretation. This includes filtering and normalization of raw data, and mapping of the data to particular Key Performance Indicators (KPIs) and use case templates.

Domain-specific analytics solutions allow operators to organize the resulting analytics events and alerts into particular business needs, such as home device analytics, online video analytics, or security analytics.

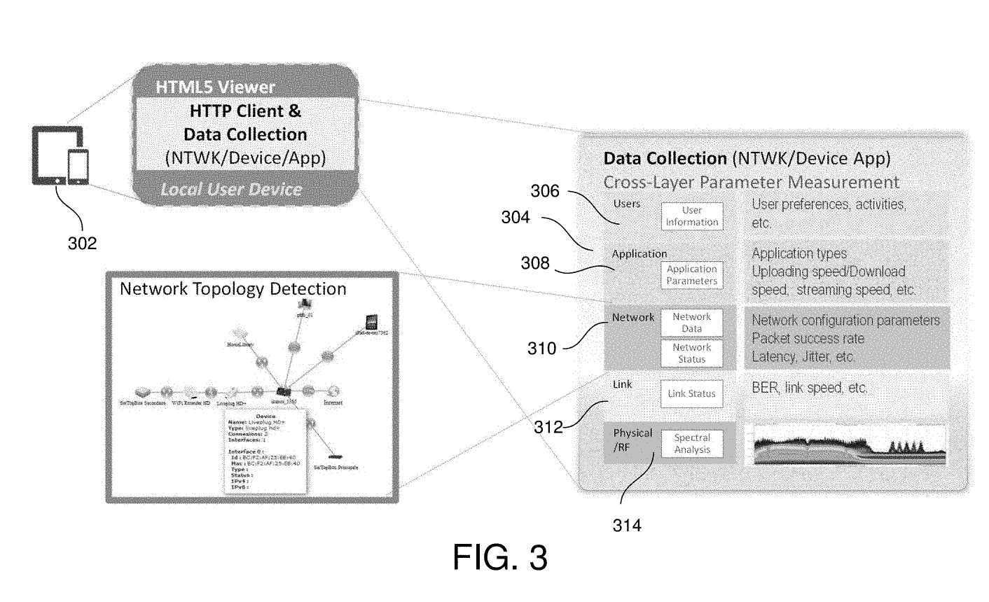

FIG. 3 is an illustration of one example of an architecture that can be implemented in some embodiments of the disclosed method and apparatus to provide fault detection and analysis in accordance with the disclosed method and apparatus. A local user device 302, such as an IoT device, tablet or smart phone, provides a resource for performing local data collection. The local user device 302 is coupled to the wireless network. A cross-layer parameter measurement application 304 run on the user device 302 has a module 306 for maintaining user preferences, activities, etc. A second module 308 maintains parameters related to the application types that are present, the upload and download speeds, streaming speeds, etc. A third module 310 provides network configuration parameters, packet success rates, information regarding latency, jitter, etc. A fourth module 312 collects and maintains parameters, such as bit error rate, link speed, etc. A fifth module 314 collects and maintains parameters related to the physical layer (PHY layer) and radio frequency layer (RF layer), such as parameters measured based on a spectral analysis of the RF, IF and baseband signals.

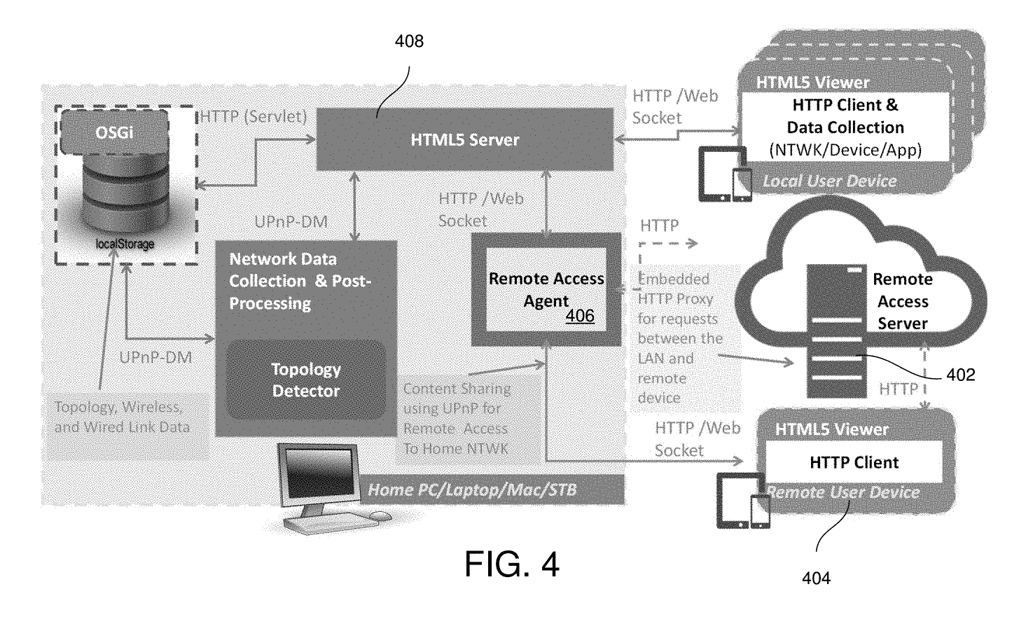

FIG. 4 is an illustration of an architecture that may be implemented in one example of the disclosed method and apparatus. In this embodiment, a remote access server 402 is coupled to a remote user device 404. A remote access agent 406 is provided to facilitate communication between the remote user device 404 and a server 408.

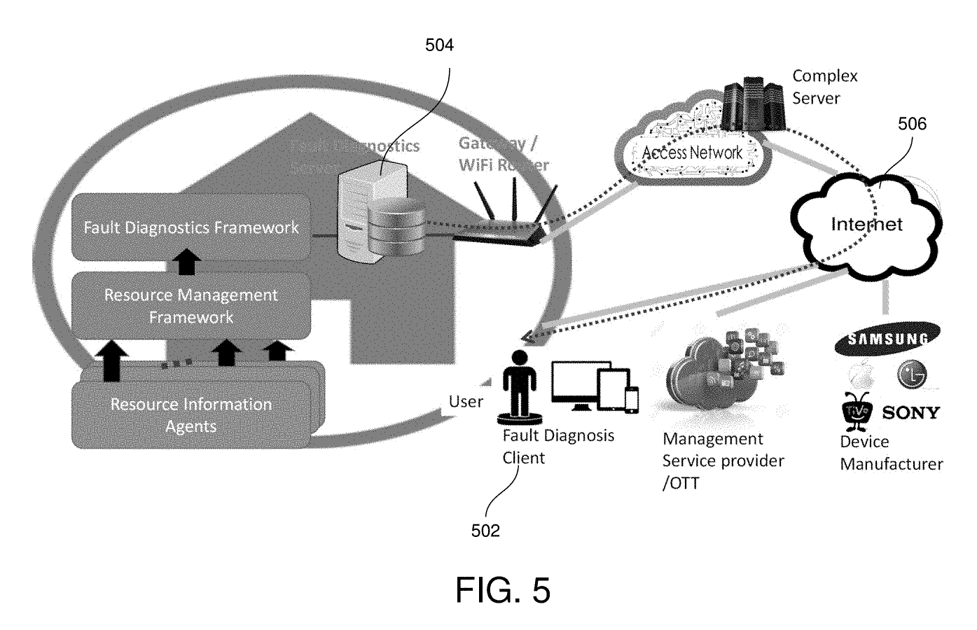

FIG. 5 is an illustration of another example of an architecture in which a fault diagnostic client 502 communicates with a fault diagnostic server 504 through the internet 506.

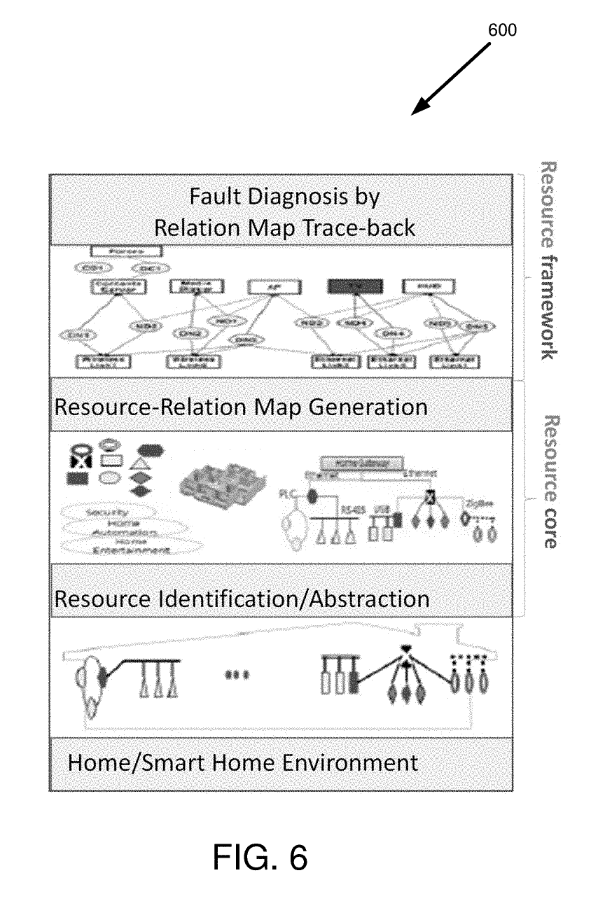

FIG. 6 is an illustration of a smart home environment 600 and the associated logical components of such a smart home environment 600 in accordance with the disclosed method and apparatus.

What is claimed is:

1. A network fault diagnostics platform, comprising:
(a) a diagnostic platform configured to capture radio signal impairments; and
(b) a statistical analysis processor configured to receive known faults having a unique fault signature and to point to the root cause of the fault.
